(19) United States
(12) Patent Application Publication
(10) Pub. No.: US 2011/0231784 A1
(43) Pub. Date: Sep. 22, 2011

(54) SYSTEM AND METHOD FOR DESKTOP APPLICATION MIGRATION

(75) Inventors: Xin MENG, Beijing (CN); Cailiang SONG, Beijing (CN); Jingwei SHI, Beijing (CN); Lian WANG, Beijing (CN); Huifeng LIU, Beijing (CN); Xiaowei LIU, Beijing (CN)

(73) Assignee: NEC (CHINA) CO., LTD., Beijing (CN)

(21) Appl. No.: 13/012,464

(22) Filed: Jan. 24, 2011

(30) Foreign Application Priority Data
Mar. 17, 2010 (CN) 201010130159.7

(51) Int. Cl. G06F 3/048

(52) U.S. Cl. 715/762

(57) ABSTRACT

The present invention provides a system and a method for desktop application migration, which are divided to a development phase and an actual runtime phase. During the development phase, interface description data of each window are dumped by traversing all windows of a desktop application; a raw template is semi-automatically generated using the interface description data of each window; it is further designated manually and/or according to rules which parts are “data-type interface elements” based on the raw template, so as to form a final template. During the actual runtime phase, the interface description data of the desktop application are obtained in real time, and values and attribute information of the “data-type interface elements” are dumped therefrom for filling in the template, in order to form a finally-presented webpage. The present invention significantly improves efficiency of creating a new web application and saves development costs by semi-automatically generating the templates.

### FIELD OF INVENTION

The present invention relates to a field of computer application migration, and particularly, relates to a system and a method for desktop application migration based on templates.

### DESCRIPTION OF PRIOR ART

With the development of cloud computing and the Internet, people increasingly prefer to access services anytime and anywhere. However, an existing large number of desktop applications (a stand-alone application or a client-server version of application) require that a user must firstly install a client before corresponding operations may be performed, rather than providing services anytime and anywhere. If the existing system is discarded and a browser-server version of system which has the same set of functions is re-developed, the development costs are too high, and cause a waste of the original system. Therefore, a set of highly efficient desktop application migration schemes is desirable.

Here, the meaning of the “desktop application migration” is that the existing desktop applications and resources thereof are used for completing their web applications with a little of development amount by means of migration. Interfaces and functions of the web applications are basically the same as those of the existing desktop applications.

The meaning of the “migration” is that the existing desktop applications are run and their interfaces are re-drawn to be presented to the user in a form of webpage or other forms which may present by other network clients; after the user performs an operation on the webpage, the operation is presented on the desktop application, so as to complete a corresponding function; then an updated interface is re-drawn and presented to the user. Thus, developers may develop web applications in a short time without considering function implementation details, such as data access, logic flows and algorithm implementations, of the desktop applications.

Currently, there are mainly two approaches for migrating the desktop application to the web application.

One approach is that a corresponding webpage may be generated according to real-time GUI (Graphic User Interface) interface information, e.g. a shot of the interface, essential attribute information of each interface element/control element etc., of the desktop application. Its disadvantage is that a large amount of time will be taken for generating all of webpage elements.

The other approach is that a template of the webpage may be made offline, i.e. previously; and then the webpage may be generated quickly according to the template. This is a better solution compared to the above approach.

The Chinese patent CN 1555534A discloses a method and a system for delivering dynamic information in a network, wherein a network server searches for corresponding template and dynamic data after a request is received, and then transmit them to a browser. The browser will present the dynamic information.

In particular, FIG. 1 shows an illustrative block diagram of the system as disclosed in CN 1555534A. As illustrated in FIG. 1, various modules have functions as follows:
a request parsing unit 110 located at a server 100 side, adapted for parsing an HTTP request (URL) from a browser 200, so as to know which dynamic webpage the browser 200 requests;
a data searching unit 120 located at the server 100 side, adapted for searching a database 170 for related data according to a parsing result of the request parsing unit 110, the searched data being used for generating dynamic parts in the webpage;
a module accessing unit 130 located at the server 100 side, adapted for acquiring a requested particular template according to the parsing result of the request parsing unit 110;
a variable assignment unit 140 located at the server 100 side, adapted for assigning variables in the particular template acquired by the module accessing unit 130, i.e. assigning specific data searched by the data searching unit 120 to the variables in the particular template acquired by the module accessing unit 130;
a sending unit 140 located at the server 100 side, adapted for sending the assigned template to the browser 200 as a response to the HTTP request (URL) as transmitted from the browser 200;
a rendering unit 210 located at the browser 200 side, adapted for rendering (displaying) the dynamic webpage to the browser 200.

FIG. 2 shows a particular example of the template as disclosed in CN 1555534A. As illustrated in FIG. 2, the template consists of a view portion and a data portion. The view portion is a main part of the template, which is written by a programmer in advance. A variable part of the view portion may be represented by variables (“Table1.msg1” and “Table1.msg2” surrounded by a dash line block). The data portion may be filled in by the variable assignment unit 140. The specific data as retrieved from the database 700 are replaced with the corresponding variables (“Table1.msg1” and “Table1.msg2” surrounded by a dash line block) existing in the view portion. In FIG. 2, the browser 200 replaces the variables “Table1.msg1” and “Table1.msg2” with specific data as follows:
“Table1.msg1” is replaced with msg1; and “Table1.msg2” is replaced with msg2.

However, the existing solution as disclosed in CN 1555534A has disadvantages as follows:
1. All of the templates must be completed by the programmer manually, which has very low development efficiency, especially for the case of more pages, when a web application is implemented based on the existing desktop application (the interfaces and functions of the web application being completely or mostly the same as those of the desktop application, i.e. “desktop application migration” as defined in the specification), rather than developing an new web application;
2. The developers of web application generally cannot obtain the database for the desktop application, and thus cannot directly dump data information and use the information to fill in the templates.

### SUMMARY OF THE INVENTION

In order to overcome the above disadvantages in the prior art, the present invention provides a system and a method for desktop application migration, which are divided to a development phase and an actual runtime phase. During the development phase, interface description data of each window are dumped by traversing all windows of a desktop application; a raw template is semi-automatically generated using the interface description data of each window; it is further designated manually and/or according to rules which parts are “data-type interface elements” based on the raw template, so as to form a final template. During the actual runtime phase, the interface description data of the desktop application are obtained in real time, and values and attribute information of the “data-type interface elements” are dumped therefrom for filling in the template, in order to form a finally-presented webpage.

According to a first aspect of the present invention, a server is provided. The server comprises a window traversing unit for traversing all windows, menu items and/or dialogue boxes of a desktop application; an interface information dumping unit for dumping interface information for each window of the desktop application and organizing the interface information into interface description data; and a template generating unit for generating a raw template based on the interface description data, designating data-type elements in the raw template, adding a processing script for each data-type element to generate a final template, and storing the final template into a template database.

Preferably, the server may comprises an interface-jumping-relation dumping unit for automatically recording jumping relations among respective windows of the desktop application according to the traversing procedure of the window traversing unit, and storing the jumping relations into an interface relation database.

Preferably, the template generating unit may comprise an interface generating unit for generating a desired static page based on the interface description data; a response function generating unit for adding a corresponding response function for each interface element/control element, wherein when the interface element/control element is operated, the response function is triggered and operates to send action description data to a server; and a data-type element defining unit for designating the data-type elements in the raw template, adding a processing script for each data-type element to generate the final template, and storing the final template into a template database.

Preferably, the template generating unit may automatically designate the data-type elements in the raw template based on a configuration file which specifies which attribute(s) of which type(s) of control element(s) is a data-type element.

According to a second aspect of the present invention, a template generating method for desktop application migration is provided. The method comprises: traversing all windows, menu items and/or dialogue boxes of a desktop application; dumping interface information for each window of the desktop application and organizing the interface information into interface description data; generating a raw template based on the interface description data; and designating data-type elements in the raw template, adding a processing script for each data-type element to generate a final template, and storing the final template into a template database.

Preferably, the template generating method for desktop application migration may further comprise: recording jumping relations among respective windows of the desktop application, and storing the jumping relations into an interface relation database.

Preferably, the step of generating a raw template may comprise generating a desired static page based on the interface description data; and adding a corresponding response function for each interface element/control element, wherein when the interface element/control element is operated, the response function is triggered and operates to send action description data to a server.

Preferably, the data-type elements in the raw template may be automatically designated based on a configuration file which specifies which attribute(s) of which type(s) of control element(s) is a data-type element.

According to a third aspect of the present invention is provided. The server comprises a request parsing unit for parsing a request for a desktop application from a browser to obtain action description data; an action replaying unit for replaying operations for the desktop application based on the action description data; an interface information dumping unit for dumping interface information for a current window of the desktop application and organizing the interface information into interface description data; and a sending unit for sending the interface description data to the browser.

Preferably, the server may further comprise: a new window judging unit for determining a new window pops up based on the interface description data; and a template accessing unit for searching and accessing a template corresponding to the new window in a template database, wherein the sending unit is further for sending the accessed template to the browser. More preferably, the server may further comprise: a template generating unit for, in a case where a desired template is not found, generating a raw template based on the interface description data, designating data-type elements in the raw template, adding a processing script for each data-type element to generate a final template, and storing the final template into the template database.

Preferably, the server may further comprise: a new window judging unit for determining a new window pops up by retrieving an interface relation database based on the action description data; and a template accessing unit for searching and accessing a template corresponding to the new window in a template database, wherein the sending unit is further for sending the accessed template to the browser. More preferably, the server may further comprise: a template generating unit for, in a case where a desired template is not found, generating a raw template based on the interface description data, designating data-type elements in the raw template, adding a processing script for each data-type element to generate a final template, and storing the final template into the template database; and an interface-jumping-relation dumping unit for recording jumping relations among respective windows relevant to the final template, and storing the jumping relations into an interface relation database.

According to a fourth aspect of the present invention, a template-based desktop application migrating method is provided. The method comprises: at a server side, parsing a request for a desktop application from a browser to obtain action description data; replaying operations for the desktop application based on the action description data; dumping interface information for a current window of the desktop application and organizing the interface information into interface description data; and sending the interface description data to the browser; and at the browser side, parsing the interface description data to extract the corresponding interface information; and filling in data-type elements in a template according to the interface information.

Preferably, the template-based desktop application migrating method may further comprise: at the server side, determining a new window pops up based on the interface description data; searching and accessing a template corresponding to the new window in a template database; and sending the accessed template to the browser; and at the browser side, filling in the data-type elements in the received template according to the interface information. More preferably, the template-based desktop application migrating method may further comprise at the server side, in a case where a desired template is not found, generating a raw template based on the interface description data; designating data-type elements in the raw template, adding a processing script for each data-type element to generate a final template, and storing the final template into the template database; and sending the final template to the browser.

Preferably, the template-based desktop application migrating method may further comprise: at the server side, determining a new window pops up by retrieving an interface relation database based on the action description data; searching and accessing a template corresponding to the new window in a template database; and sending the accessed template to the browser; and at the browser side, filling in the data-type elements in the received template according to the interface information. More preferably, the template-based desktop application migrating method may further comprise: at the server side, in a case where a desired template is not found, generating a raw template based on the interface description data; designating data-type elements in the raw template, adding a processing script for each data-type element to generate a final template, and storing the final template into the template database; recording jumping relations among respective windows relevant to the final template, and storing the jumping relations into an interface relation database; and sending the final template to the browser.

Preferably, the step of filling in data-type elements may comprise: locating a data-type element in the interface information; locating a corresponding data-type element in the template; and replacing a value of the corresponding data-type element in the template with a value of the data-type element in the interface information.

Or, preferably, the step of filling in data-type elements may comprise: locating a data-type element in the template; locating a corresponding data-type element in the interface information; and replacing a value of the data-type element in the template with a value of the corresponding data-type element in the interface information.

Compared to the most related prior art, the advantages of the present invention at least comprise:
the present invention may significantly improve efficiency of creating a new web application and saves development costs by semi-automatically generating the templates.

### BRIEF DESCRIPTION OF THE DRAWINGS

The above and other objects, features and advantages of the present invention will be more apparent by descriptions on embodiments of the present invention with reference to the drawings, in which:

FIG. 1 shows a block diagram of a system as disclosed in CN 1555534A;

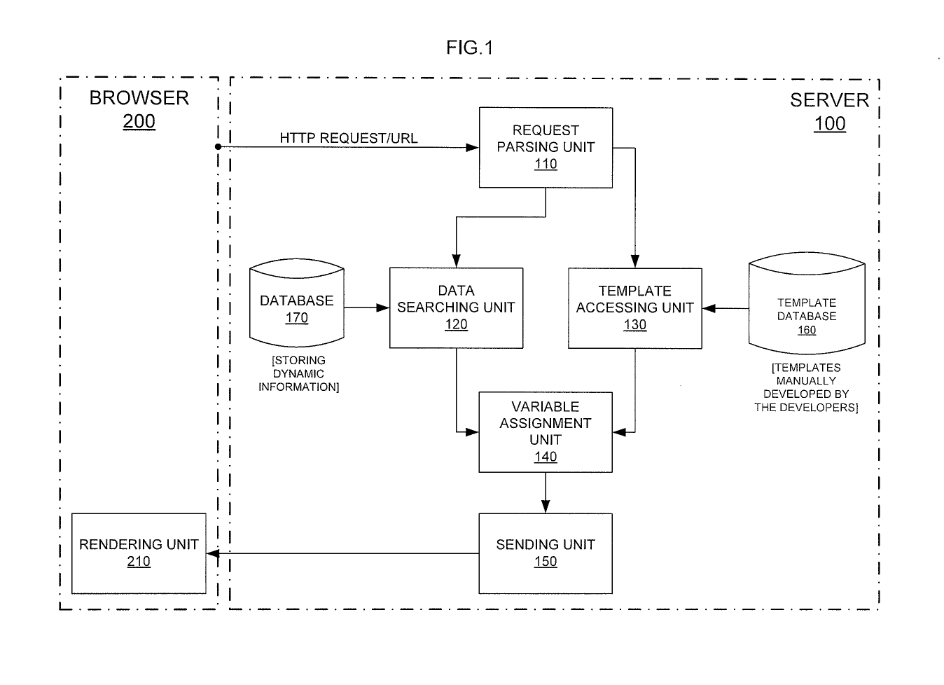

FIG. 2 shows a particular example of a template as disclosed in CN 1555534A;

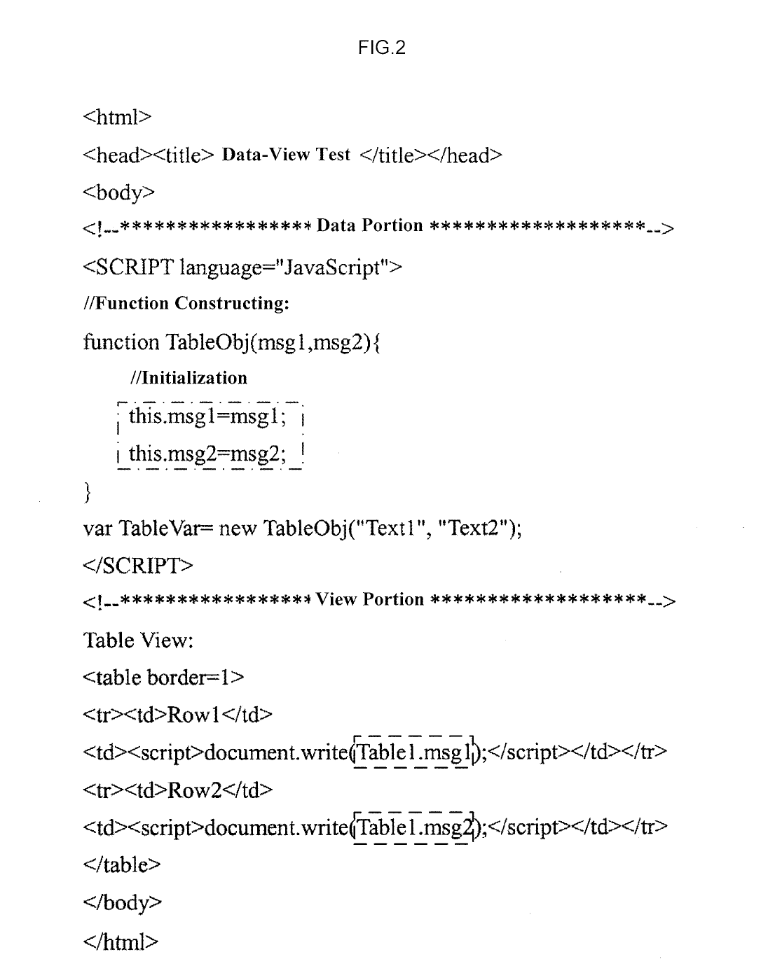

FIG. 3 shows an illustrative structure block diagram of a server 300 during a template generation phase according to a first embodiment of the present invention;

FIG. 4 shows illustrative structure block diagrams of the server 300 and a browser 400 during a runtime phase according to the first embodiment of the present invention;

FIG. 5 shows an illustrative structure block diagram of a server 500 during a template generation phase according to a second embodiment of the present invention;

FIG. 6 shows illustrative structure block diagrams of the server 500 and a browser 600 during the runtime phase according to the second embodiment of the present invention;

FIG. 7 shows illustrative structure block diagrams of an improved server 300 and the browser 400 during the runtime phase according to the first embodiment of the present invention;

FIG. 8 shows illustrative structure block diagrams of an improved server 500 and the browser 600 during the runtime phase according to the second embodiment of the present invention;

FIG. 9 shows an application instance during the template generation phase; and

FIG. 10 shows an application instance during the runtime phase.

The same reference numbers in the drawings represent the related units, so as to show their relativities.

### DETAILED DESCRIPTION OF PREFERRED EMBODIMENTS

Hereinafter, the present invention will be further described in detail by referring to the embodiments as shown in the drawings. However, it should be understood that the descriptions are only Illustrative but do not make any limitations on the scope of the present invention. Additionally, the following explanations omit descriptions on well-known structures and techniques so as to avoid obscuring concepts of the present invention unnecessarily.

### First Embodiment

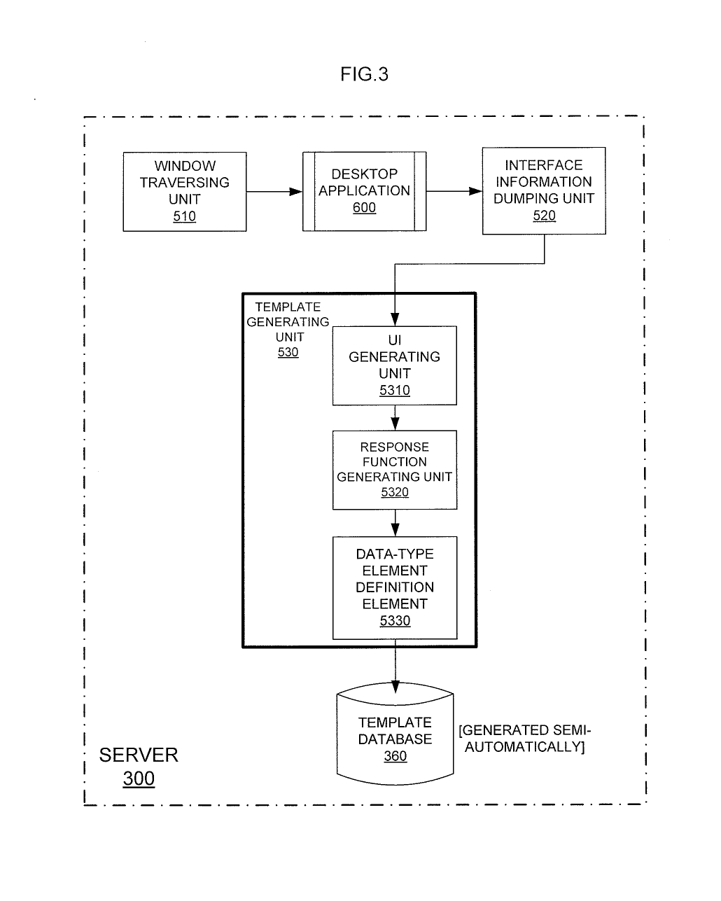

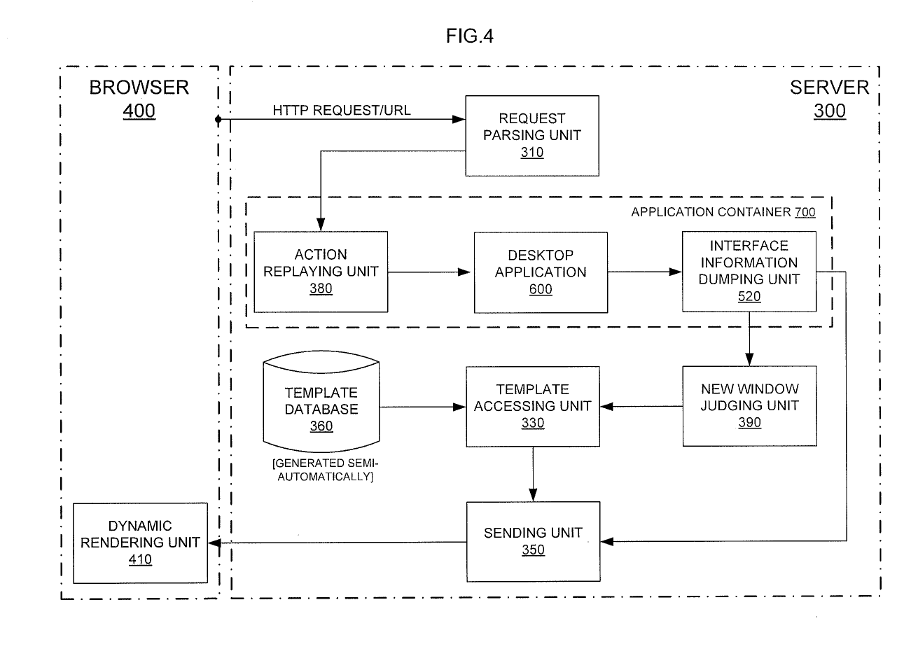

According to the first embodiment, a method for desktop application migration based on a template may comprise a template generation phase and a runtime phase. Hereinafter, the embodiment will be described in detail in connection with FIGS. 3 and 4.

FIG. 3 shows the illustrative structure block diagram of the server 300 during the template generation phase according to the embodiment.

As shown in FIG. 3, the server 300 comprises a desktop application 600, a window traversing unit 510, an interface information dumping unit 520, a template generating unit 530 and a template database 360, which are installed at the side of the server 300.

During the template generation phase, the desktop application 600 performs corresponding operations according to instructions from the window traversing unit 510, and returns corresponding outputs (windows, response information etc.).

The window traversing unit 510 may be used for traversing all windows, menu items and/or dialogue boxes of the desktop application 600. The traversing process may be completed manually or semi-automatically. For example, the window traversing unit 510 operates each of operable control elements in a main window one by one to obtain respective children windows. The process is repeated until all of the windows of the desktop application 600 are traversed.

The interface information dumping unit 520 may dump interface information of each window from the desktop application 600, and organize the information to interface description data. The interface description data may use descriptive language formats such as XML, HTML, WML, etc. The present invention does not make any limitations on this point. The template generating unit 530 may be used for generating templates and storing them in the template database 360. The template database 360 may be used for storing semi-automatically generated templates.

The template generating unit 530 may further comprise an interface (UI) generating unit 5310, a response function generating unit 5320, and a data-type element definition element 5330.

The UI generating unit 5310 may generate a desired static page based on the interface description data, such as an XML webpage, an HTML webpage, a WML webpage etc, and may also generate any of representations which may be presented at a web client of course, such as Flash files etc.

The response function generating unit 5320 may add a corresponding response function for each interface element/control element. If some interface element is operated, the response function thereof will be triggered and send action description data to the server 300. The action description data contain information related to the action, e.g. which action is performed on which interface element, essential parameters for performing the action etc.

The data-type element definition element 5330 may be used for defining a data portion of the template. The data portion refers to a dynamic portion, which is generated according to actual situations during the desktop application 600 during the runtime. The data-type element definition element 5330 may automatically determine which attribute of which type of the control element is the data-type element. For example, table 1 gives instances of configuration files.

TABLE 1
Text

| | | | | Data-Type |
|---|---|---|---|---|
| Name | Role | Node Name | Attribute Name | Element? |
| Edit(TextBox)/ | text | layout | enabled | Yes |
| Static Text(Label) | | | hasfocus | Yes |
| | | | visible | Yes |
| | | | x | No |
| | | | y | No |
| | | | width | No |
| | | | height | No |
| | | | screenx | No |
| | | | screeny | No |
| | | | bgcolor | No |
| | | | forecolor | No |
| | | | fontstyle | No |
| | | window | text | Yes |
| | | specific | caption | Yes |
| | | | selectionlength | Yes |
| | | | selectionstart | Yes |
| | | | selectiontext | Yes |
| | | | protected | Yes |

For example, all of the attributes “enabled”, “hasfocus”, “visible”, “text”, “caption”, “selection length”, “selectionstart”, “selectiontext” and “protected” of the text element configuration files as shown in Table 1 are data portions (i.e. data-type elements). Of course, the configuration files may be composed and modified manually before or during the template generation phase.

Alternately, the data-type element definition element 5330 may also require that the operator manually designate which of elements are data-type elements.

The data-type element definition element 5330 will add a processing script for the data portion automatically, so that the processing script will replace corresponding data-type element with actual information on a window of the desktop application 600.

FIG. 4 shows the illustrative structure block diagrams of the server 300 and the browser 400 during the runtime phase according to the embodiment.

As illustrated in FIG. 4, the server 300 comprises a desktop application 600, a request parsing unit 310, an action replaying unit 380, an interface information dumping unit 520, a new window judging unit 390, a template accessing unit 330, a template database 360 and a sending unit 350, which are installed at the side of the server 300. The browser 400 mainly comprises a dynamic rendering unit 410.

During the runtime phase, the request parsing unit 310 parses an HTTP request (URL) from the browser 400 to obtain action description data contained in the HTTP request.

The desktop application 600, the action replaying unit 380 and the interface information dumping unit 520 which are installed at the side of the server 300 constitute an application container 700 at the server side for reproducing operations of the desktop application 600. The action replaying unit 380 converts the action description data passed by the request querying unit 310 to a command for the desktop application 600, and drives the desktop application 600 to perform the same or similar operation which may reflect a user's operation (remotely) on the browser 400. The interface information dumping unit 520 may perform operations similar with those during the template generation phase, i.e. dumping interface information for each window of the desktop application 600 and organizing the interface information into the interface description data.

The new window judging unit 390 may determine whether there is a new window popping up based on the interface description data from the interface information dumping unit 520. If there is a new window popping up, the new window judging unit 390 may notify the template accessing unit 330 of requiring a template corresponding to the new window. It there is not a new window popping up, the new window judging unit 390 does not need to perform any operations.

The template accessing unit 330 may be used for searching the template database 360 for the template designated by the new window judging unit 390, and outputting the template to the sending unit 350.

The sending unit 350 may be used for sending the interface description data from the interface information dumping unit 520 and/or the template from the template accessing unit 330 to the browser 400.

The dynamic rendering unit 410 at the browser 400 may parse the interface description data and dump corresponding interface information to fill in the data portion in the template, comprising: locating a location of the data-type element in the interface information; locating a location of the corresponding data-type element in the template; replacing a value of the corresponding data-type element in the template with a value of the data-type element in the interface information. The above two locating steps do not have a certain order, which may also be locating the location of the data-type element in the template; locating the location of the corresponding data-type element in the interface information; replacing the value of the data-type element in the template with the value of the corresponding data-type element in the interface information.

### Second Embodiment

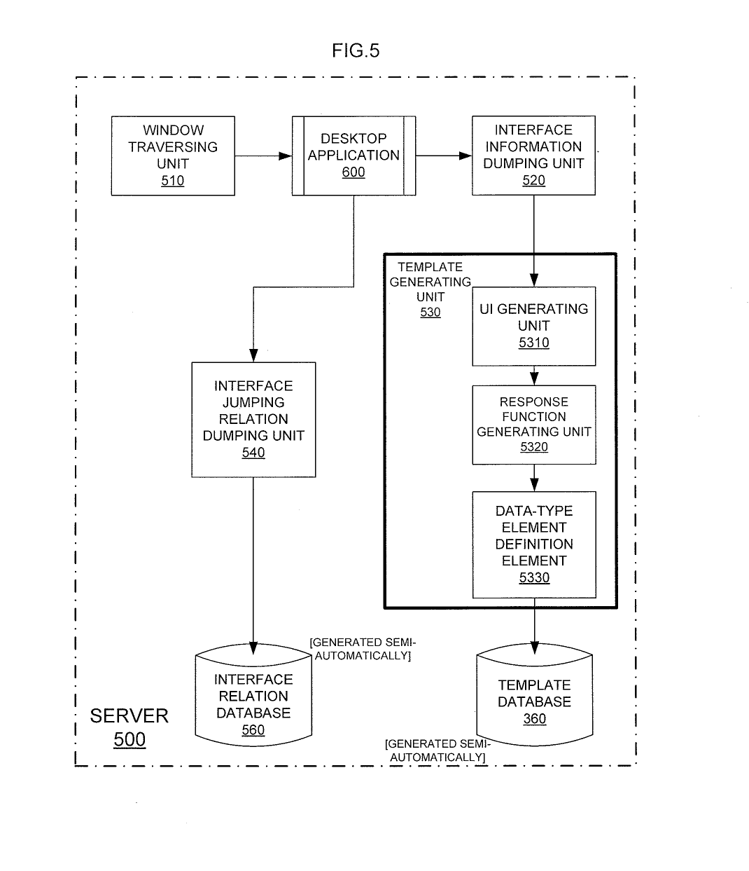

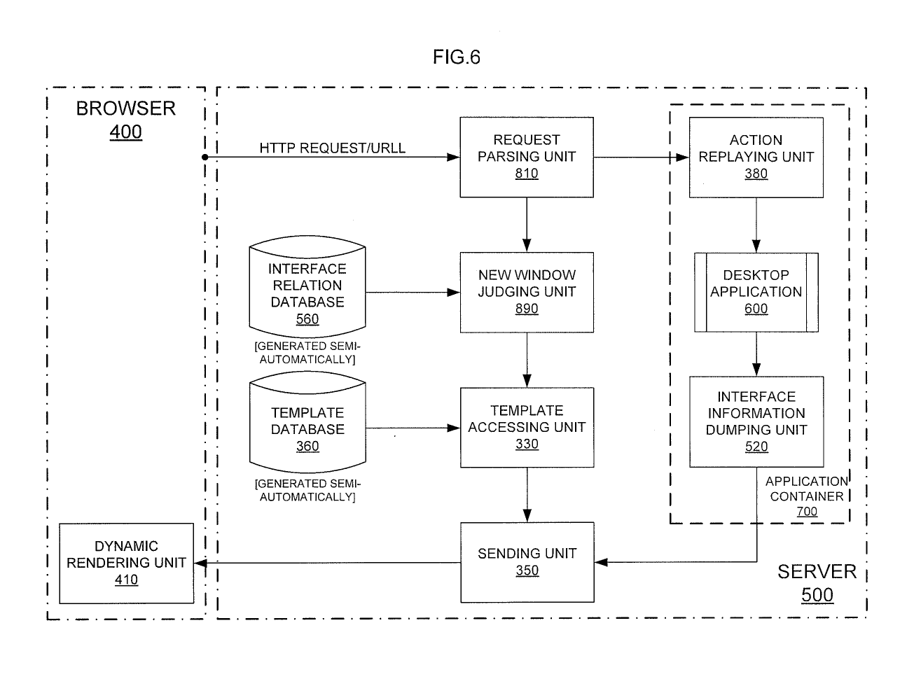

According to the second embodiment, a method for desktop application migration based on a template may also comprise a template generation phase and a runtime phase. Hereinafter, the embodiment will be described in detail in connection with FIGS. 5 and 6.

FIG. 5 shows the illustrative structure block diagram of the server 500 during the template generation phase according to the embodiment.

As shown in FIG. 5, the server 500 comprises the desktop application 600, the window traversing unit 510, the interface information dumping unit 520, the template generating unit 530 and the template database 360, which are installed at the side of the server 500. The above units and components have functions and operations which are the same as respective units as described in the first embodiment. Thus, the descriptions on the above units are omitted. Additionally, the server 500 may further comprise an interface-jumping-relation dumping unit 540 and an interface relation database 560.

During the template generation phase, the interface-jumping-relation dumping unit 540 may automatically record jumping relations among respective operation windows according to the traversing procedure of the window traversing unit 510, and store the jumping relations into the interface relation database 560, besides the same operations as described in the first embodiment. For example, when the window traversing unit 510 clicks a control element X on a window A to pop up a window B during the operation, the jumping relation about the control element X between the windows A and B may be recorded. For example, the interface jumping relation stored in the interface relation database 560 may be shown in Table 2. Table 2 further gives instances of other interface jumping relations.

TABLE 2

| Jumping Relation | Jumping Control Element | Jumping Condition |
|---|---|---|
| Window A-> Window B | Control Element X | Clicking Jumping |
| | | Control Element |
| . . . | . . . | . . . |
| Window C-> Window D | Control Element Y | Double Clicking |
| | | Jumping Control |
| | | Element |
| . . . | . . . | . . . |

Of course, the interface relation database 560 may also be generated manually or semi-automatically so as to record the jumping relations among the respective windows/interfaces/pages.

FIG. 6 shows the illustrative structure block diagrams of the server 500 and the browser 400 during the runtime phase according to the embodiment.

As illustrated in FIG. 6, the server 500 comprises the desktop application 600, a request parsing unit 810, the action replaying unit 380, the interface information dumping unit 520, a new window judging unit 890, the interface relation database 560, the template accessing unit 330, the template database 360 and the sending unit 350, which are installed at the side of the server 300. The browser 400 mainly comprises the dynamic rendering unit 410.

During the runtime phase, the request parsing unit 810 parses the HTTP request (URL) from the browser 400 to obtain action description data contained in the HTTP request.

The desktop application 600, the action replaying unit 380 and the interface information dumping unit 520 which are installed at the side of the server 300 constitute an application container 700 at the server side for reproducing operations of the desktop application 600. The action replaying unit 380 converts the action description data passed by the request querying unit 810 to a command for the desktop application 600, and drives the desktop application 600 to perform the same or similar operation which may reflect a user's operation on the browser 400 (remotely). The interface information dumping unit 520 may perform operations similar with those during the template generation phase, i.e. dumping interface information for each window of the desktop application 600 and organizing the interface information into the interface description data.

The new window judging unit 890 may query the jumping relations among the windows/interfaces/pages stored in the interface relation database 560 and determine whether there is a new window popping up, based on the action description data parsed by the request parsing unit 810. If there is a new window popping up, the new window judging unit 890 may notify the template accessing unit 330 of requiring a template corresponding to the new window. It there is not a new window popping up, the new window judging unit 890 does not need to perform any operations.

The template accessing unit 330 may be used for searching the template database 360 for the template designated by the new window judging unit 390, and outputting the template to the sending unit 350.

The sending unit 350 may be used for sending the interface description data from the interface information dumping unit 520 and/or the template from the template accessing unit 330 to the browser 400.

The dynamic rendering unit 410 at the browser 400 may parse the interface description data and dump corresponding interface information to fill in the data portion in the template, comprising: locating a location of the data-type element in the interface information; locating a location of the corresponding data-type element in the template; replacing a value of the corresponding data-type element in the template with a value of the data-type element in the interface information. The above two locating steps do not have a certain order, which may also be locating the location of the data-type element in the template; locating the location of the corresponding data-type element in the interface information; replacing the value of the data-type element in the template with the value of the corresponding data-type element in the interface information.

### Improvement 1 on First and Second Embodiments

The above first and second embodiments well implement the system and the method for desktop application migration based on the template. At the same time, the inventor notices that in most situations, the interface description data may only vary a little each time with the user's operation. In order to reduce data transmission amount and network loads and improve user's experiences, only varied interface description data may be transmitted. Therefore, in the first and the second embodiments, the interface information comparing unit 900 may be introduced for comparing the current interface description data with the previous interface description data, so as to provide the varied interface description data to the sending unit 350.

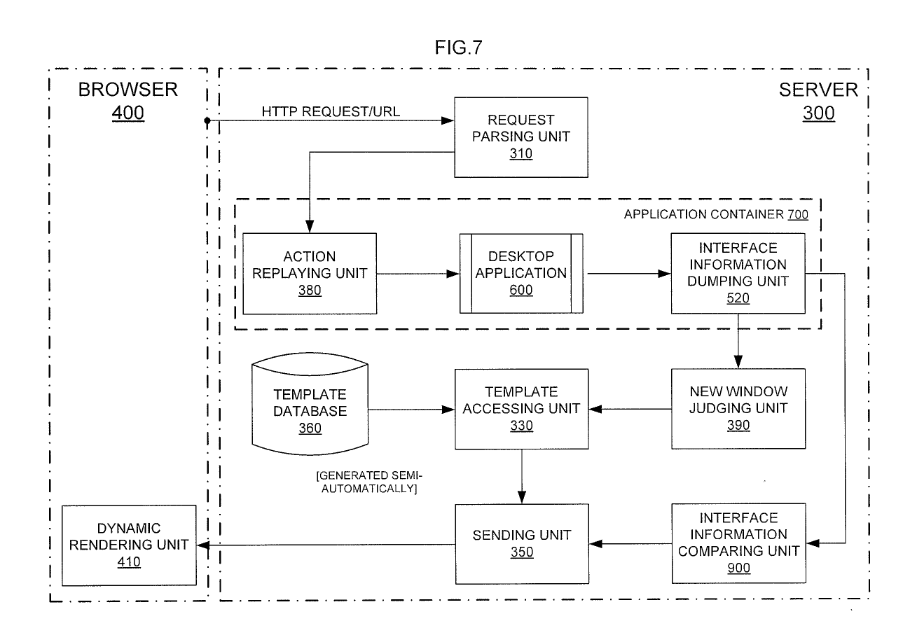

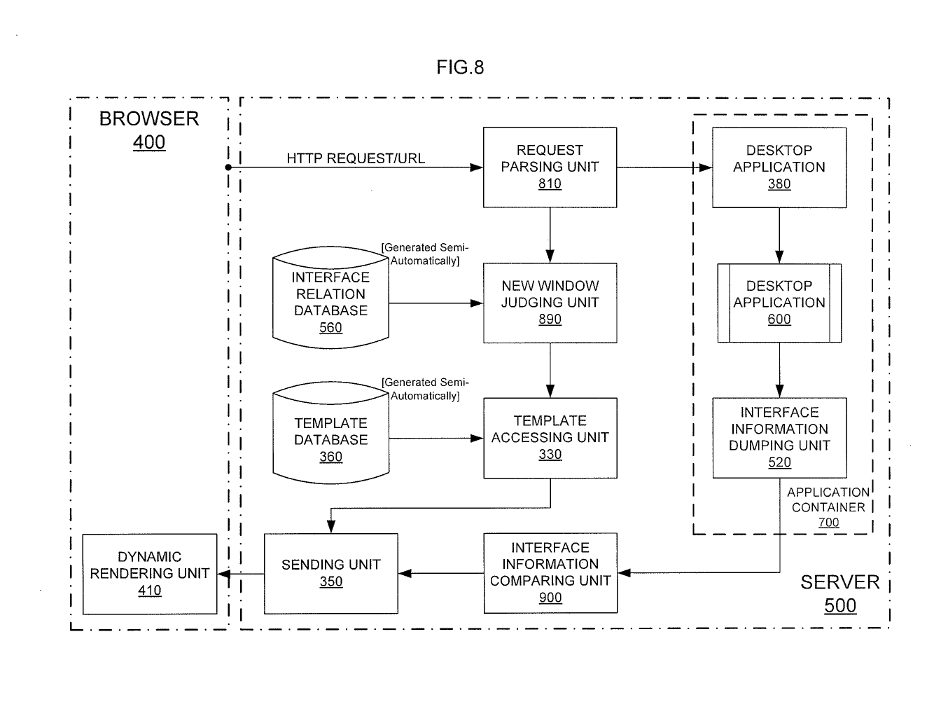

FIGS. 7 and 8 show illustrative structure block diagrams of an improved server 300/500 and the browser 400 during the runtime phase according to the first and second embodiments of the present invention, respectively.

The interface information comparing unit 900 is located between the interface information dumping unit 530 and the sending unit 350, and is adapted for comparing the current interface description data provided currently by the interface information dumping unit 520 with the current interface description data provided previously by the interface information dumping unit 520, so as to provide only the varied interface description data to the sending unit 350.

In this case, the dynamic rendering unit 410 at the browser 400 only updates the data portion in the template corresponding to the varied interface description data, the remaining data portions in the template keeping the value which is previously filled in.

### Improvement 2 on First and Second Embodiments

Furthermore, during the runtime phase, there may be situations in which interfaces/windows are not trained. That is, the template accessing unit 330 fails to find the template as designated by the new window judging unit 390/890. This illustrates that the current template database 360 is not complete yet, and needs further training and template generation.

In this case, in order to enable the method for desktop application migration according to the present invention to be performed successfully, a part of the step of generating the template, i.e. the template generating unit 530 generating a final template according to the interface description data from the interface information dumping unit 520, may be added, so as to generate a template which is absent currently, and store the template in the template database 360 (first and second embodiments). At the same time, the jumping relation among the windows related to the template may be stored in the interface relation database 560 (second embodiment, which is implemented by the interface jumping relation dumping unit 540). As such, the template accessing unit 330 may find the template as designated by the new window judging unit 390/890 in the template database 360, and output the template to the sending unit 350.

### Application Instances

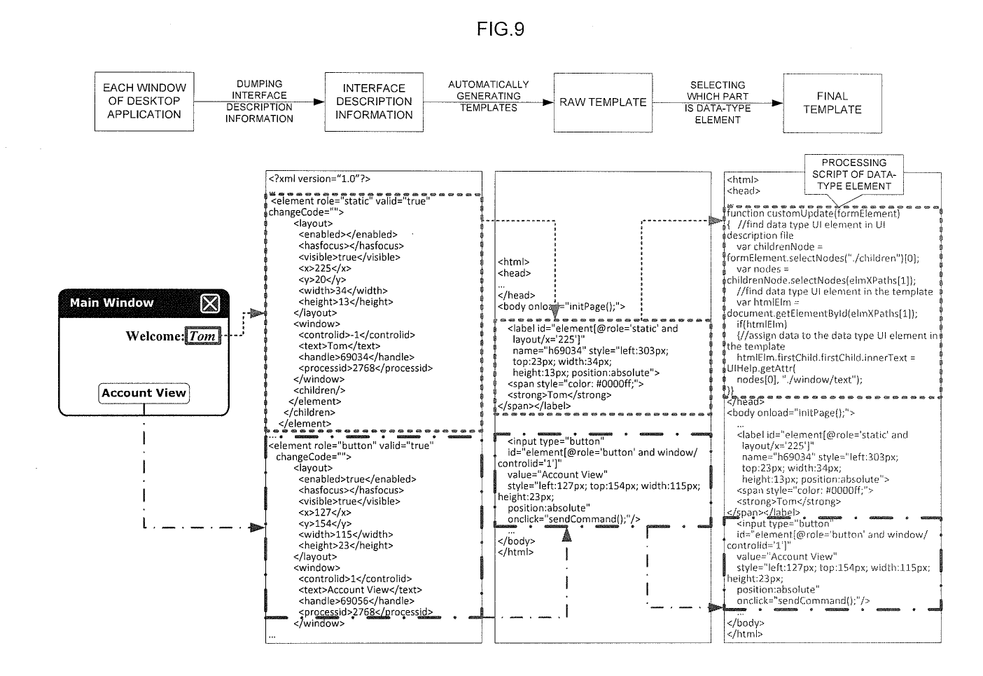

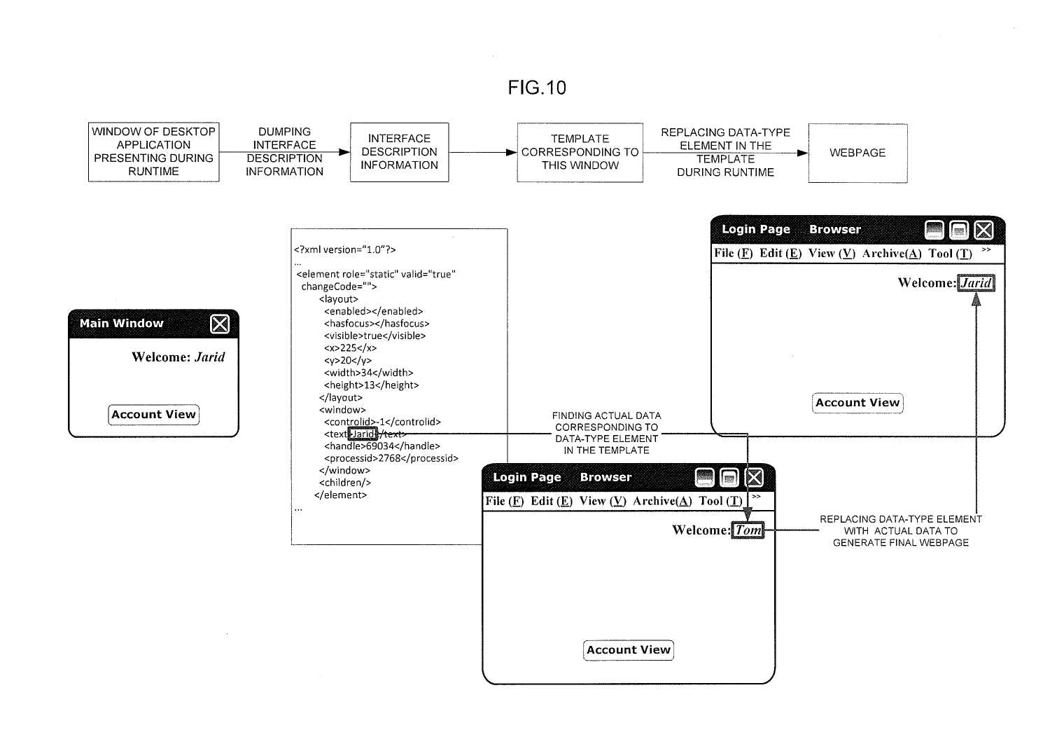

FIGS. 9 and 10 show application instances during the template generation phase and the runtime phase, respectively.

As shown in FIG. 9, during the template generation phase,
1. The window traversing unit 510 traverses each control element in the window of the desktop application 600.
2. The interface information dumping unit 520 dumps metadata information of the control element, e.g. coordinates, sizes, controlID, handles, text descriptions etc. of button control elements. The instance as illustrated in FIG. 9 gives the interface description data of user name information “Tom”, which is surrounded with a left dash line block; and the interface description data of “Account View” button, which is surrounded with a left dash dot line block.
3. The UI generating unit 3510 automatically converts the interface description data to UI descriptions, e.g. XML codes, HTML codes, WML codes etc. The instance as illustrated in FIG. 9 shows HTML codes information (which is surrounded with a middle dash line block) of the user name information “Tom” as generated according to the interface description data of the user name information “Tom”; and that HTML codes information (which is surrounded with a middle dash dot line block) of the interface description data of “Account View” button in the template as generated according to the interface description data of the “Account View” button.
4. The response function generating unit 5320 adds corresponding response functions to each interface element/control element. If some interface element is operated at the browser end, its response function will be triggered to be performed and the action description data will be transmitted to the server. The action description data contain information related to the action, e.g. which action is performed on which interface element, essential parameters for performing the action etc. The instance as illustrated in FIG. 9 shows the response function [onclick=“sendCommand( )”] of the “Account View” button. Thus, the generation of a raw template may be completed.
5. The data-type element definition unit 5330 determines which attribute of which type of the control element is the data-type element, and automatically adds the processing script to the data-type element. In the instance as illustrated in FIG. 9, the user name information after “Welcome” (“Tom” surrounded by a left solid line block) is data-type element, the processing script (surrounded by a right dash line block) for the data-type element is generated automatically.

As shown in FIG. 10, during the runtime phase,
1. During the runtime, the desktop application 600 is operated according to a request from the browser 400, and a new window appears on the desktop application 600.
2. The interface information dumping unit 520 dumps the interface description data of the window.
3. The template accessing unit 330 finds the template, i.e. the template on the right of FIG. 9, corresponding to the window.
4. The sending unit 350 sends the interface description data and the found template to the browser 400 side.
5. The dynamic rendering unit 410 at the browser 400 side finds the data-type element in the template.
6. The dynamic rendering unit 410 finds actual data corresponding to the data-type element in the interface description data. In the instance illustrated in FIG. 10, the actual data is “Jarid”.
7. The dynamic rendering unit 410 replaces the value “Tom” of the data-type element with the value “Jarid” of actual data, so as to generate a final browser webpage (the webpage at the right of FIG. 10) for presenting on the browser 400.

Other arrangements of the embodiments in the present invention disclosed here comprise software programs of steps and operations of the method embodiments previously generalized and described in detail later. Particularly, the computer program products may be an embodiment which has computer readable medium with computer program logics being coded thereon. The computer program logics may provide related operations when executed on a computing device, so as to provide the above desktop application migration scheme. When the computer program logics are executed on at least one of the processors of the computing system, they enable the processor to perform the operations (method) as described in the embodiments of the present invention. Such arrangements of the present invention typically provide software, codes and/or other data structures arranged or encoded on the computer readable medium such as optical medium (e.g. CD-ROM), floppy disk or hard disk etc., or other media such as firmware or micro codes on one or more ROM or RAM or PROM chips, or downloadable software images, shared database in ASIC (Application Specific Integrated Circuit), or one or more modules. Software or firmware or such arrangements may be installed on the computing device, so as to enable one or more processors in the computing device to perform the techniques as described in the embodiments of the present invention. Software process operating with a set of data communication devices or computing devices in other entities may also provide the system according to the present invention. The system according to the present invention may also be distributed over a plurality of software processes on the plurality of data communication devices, or all of software processes running on a set of small-size dedicated computers, or all of software processes running on a single computer.

It should be understood that strictly speaking, the embodiments of the present invention may be implemented in software programs, software and hardware, or separate software and/or separate circuits.

The above is only the preferred embodiments of the present invention and the present invention is not limited to the above embodiments. Therefore, any modifications, substitutions and improvements to the present invention are possible without departing from the spirit and scope of the present invention.

What is claimed is:

1. A server, comprising:
a window traversing unit for traversing all windows, menu items and/or dialogue boxes of a desktop application;
an interface information dumping unit for dumping interface information for each window of the desktop application and organizing the interface information into interface description data; and
a template generating unit for generating a raw template based on the interface description data, designating data-type elements in the raw template, adding a processing script for each data-type element to generate a final template, and storing the final template into a template database.

2. The server according to claim 1, further comprising:
an interface-jumping-relation dumping unit for automatically recording jumping relations among respective windows of the desktop application according to the traversing procedure of the window traversing unit, and storing the jumping relations into an interface relation database.

3. The server according to claim 1, wherein
the template generating unit comprises:
an interface generating unit for generating a desired static page based on the interface description data;
a response function generating unit for adding a corresponding response function for each interface element/control element, wherein when the interface element/control element is operated, the response function is triggered and operates to send action description data to a server; and
a data-type element defining unit for designating the data-type elements in the raw template, adding a processing script for each data-type element to generate the final template, and storing the final template into a template database.

4. The server according to claim 1, wherein
the template generating unit automatically designates the data-type elements in the raw template based on a configuration file which specifies which attribute(s) of which type(s) of control element(s) is a data-type element.

5. A server, comprising:
a request parsing unit for parsing a request for a desktop application from a browser to obtain action description data;
an action replaying unit for replaying operations for the desktop application based on the action description data;
an interface information dumping unit for dumping interface information for a current window of the desktop application and organizing the interface information into interface description data; and
a sending unit for sending the interface description data to the browser.

6. The server according to claim 5, wherein
the server further comprises:
a new window judging unit for determining a new window pops up based on the interface description data; and
a template accessing unit for searching and accessing a template corresponding to the new window in a template database,
wherein the sending unit is further for sending the accessed template to the browser.

7. The server according to claim 6, wherein
the server further comprises:
a template generating unit for, in a case where a desired template is not found, generating a raw template based on the interface description data, designating data-type elements in the raw template, adding a processing script for each data-type element to generate a final template, and storing the final template into the template database.

8. The server according to claim 5, wherein
the server further comprises:
a new window judging unit for determining a new window pops up by retrieving an interface relation database based on the action description data; and
a template accessing unit for searching and accessing a template corresponding to the new window in a template database,
wherein the sending unit is further for sending the accessed template to the browser.

9. The server according to claim 8, wherein
the server further comprises:
a template generating unit for, in a case where a desired template is not found, generating a raw template based on the interface description data, designating data-type elements in the raw template, adding a processing script for each data-type element to generate a final template, and storing the final template into the template database; and
an interface-jumping-relation dumping unit for recording jumping relations among respective windows relevant to the final template, and storing the jumping relations into an interface relation database.

10. A template-based desktop application migrating method, comprising:
at a server side,
parsing a request for a desktop application from a browser to obtain action description data;
replaying operations for the desktop application based on the action description data;
dumping interface information for a current window of the desktop application and organizing the interface information into interface description data; and
sending the interface description data to the browser; and
at the browser side,
parsing the interface description data to extract the corresponding interface information; and
filling in data-type elements in a template according to the interface information.

11. The template-based desktop application migrating method according to claim 10, further comprising:
at the server side,
determining a new window pops up based on the interface description data;
searching and accessing a template corresponding to the new window in a template database; and
sending the accessed template to the browser; and
at the browser side,
filling in the data-type elements in the received template according to the interface information.

12. The template-based desktop application migrating method according to claim 11, further comprising:
at the server side,
in a case where a desired template is not found, generating a raw template based on the interface description data;
designating data-type elements in the raw template, adding a processing script for each data-type element to generate a final template, and storing the final template into the template database; and
sending the final template to the browser.

13. The template-based desktop application migrating method according to claim 11, further comprising:
at the server side,
determining a new window pops up by retrieving an interface relation database based on the action description data;
searching and accessing a template corresponding to the new window in a template database; and
sending the accessed template to the browser; and
at the browser side,
filling in the data-type elements in the received template according to the interface information.

14. The template-based desktop application migrating method according to claim 13, further comprising:
at the server side,
in a case where a desired template is not found, generating a raw template based on the interface description data;
designating data-type elements in the raw template, adding a processing script for each data-type element to generate a final template, and storing the final template into the template database;
recording jumping relations among respective windows relevant to the final template, and storing the jumping relations into an interface relation database; and
sending the final template to the browser.

15. The template-based desktop application migrating method according to claim 10, wherein
the step of filling in data-type elements comprises:
locating a data-type element in the interface information;
locating a corresponding data-type element in the template; and
replacing a value of the corresponding data-type element in the template with a value of the data-type element in the interface information.

16. The template-based desktop application migrating method according to claim 10, wherein
the step of filling in data-type elements comprises:
locating a data-type element in the template;
locating a corresponding data-type element in the interface information; and
replacing a value of the data-type element in the template with a value of the corresponding data-type element in the interface information.
